(19) United States
(12) Patent Application Publication
(10) Pub. No.: US 2006/0142062 A1
(43) Pub. Date: Jun. 29, 2006

(54) Communication device for connection to an external acoustic transducer

(75) Inventors: Stefan Eder, Grafenau (DE); Fan Yung Ma, Singapore (SG)

Correspondence Address: SLATER & MATSIL LLP, 17950 PRESTON ROAD, SUITE 1000, DALLAS, TX, 75252, US

(73) Assignee: Infineon Technologies AG

(21) Appl. No.: 11/363,776

(22) Filed: Feb. 28, 2006

Related U.S. Application Data
(63) Continuation of application No. PCT/SG03/00200, filed on Aug. 29, 2003.

(51) Int. Cl. H04B 1/38

(52) U.S. Cl. 455/557

(57) ABSTRACT

A communication device has a socket 41 for connection to a plug 47 of an external acoustic transducer device 35, 37. The communication device includes a phone chip 101 for communicating with the external acoustic transducer device via the plug and socket. The phone chip 101 has an interface 39 electrically connected to the socket, and is enabled to detect an impendence between at least two contacts of the socket, and thereby determine if the socket is connected to the plug. Typically, this test is carried out at intervals, and when it is carried out according to the result of the determination, generates an interrupt signal that can modify how the phone chip 101 operates the interface 39.

This application is a continuation of co-pending International Application No. PCT/SG2003/000200, filed Aug. 29, 2003, which designated the United States and was published in English, which application is incorporated herein by reference.

### TECHNICAL FIELD

The present invention relates to a communication device that is adapted to determine if it is connected to an acoustic transducer.

### BACKGROUND

FIG. 1 shows the structure of a known digital communication device, such as a digital telephone. Its processing ability is based on a one-piece electrical component 1 referred to as a “phone chip.” The phone chip includes an analog front end (AFE) unit 3, which drives a built-in speaker 5 and which receives signals from a built-in microphone 7. The structure further includes a digital signal processing unit 9 (typically including both a ROM 11 and RAM 13), and a host CPU 15 (which may have access to an external memory 17). The processing unit 9 and CPU 15 manage communication with other communication devices via a communication line (e.g., a telephone line), which is not shown in FIG. 1. The phone chip 1 also includes a TSF (terminal specific functions) unit 19 that interfaces to the user interface components of the telephone, particularly to a keypad 21 (via a key scan unit 23 of the TSF 19), to LEDs 25 (via an LED Multiplexer unit 27 of the TSF 19), and to a display 29 (typically via pulse with modulators (PWMs) 31) and a bus 33 (typically of the kind referred to as an I²C bus).

Conventionally, the telephone can also be connected to one or more external acoustic transducers. These acoustic transducers may include an external handset 35 and/or an external headphone set 37. The phone chip 1 needs to know whether one of the acoustic transducers 35, 37 is connected, and if so which one. A first reason for this is so that, if the acoustic transducers are not connected, the communication device can save power by not powering the socket to which the transducer is connected. Another reason is for system diagnostics purposes, e.g., to generate an error message in the case that the acoustic transducers 35, 37 are missing. Another and very important reason is that, in some existing communication devices, only one channel is supported, so only one loudspeaker and one microphone can be connected at the same time.

A first way in which this is conventionally realized is shown in FIG. 2, in which, for simplicity, the components of the phone chip 1 other than the AFE 3 and host CPU 15 are omitted. The phone chip 1 includes an interface 39 having inputs and/or outputs (four are shown, but the number is not limited) for electrical connection to respective electrical contacts 43 of a socket 41. The electrical contacts 43 of the socket 41 are for connection to respective contacts 45 of a plug 47 of the headset 37. The phone chip 1 further includes a separate input line 49 that is electrically connected to a voltage high 51 via a resistor 53, and to a mechanical switch 55 within the socket 41. The mechanical switch 55 is configured, when the plug 47 is inserted into the socket 41, to connect the line 49 to a ground 57. (In FIG. 2, the mechanical switch 55 is shown as comprising a resilient element 59 that is deformed by the insertion of the plug 47 into the socket 41 so as to form an electrical contact between the line 49 and the ground 57). Thus, the line 49 is voltage high when the plug 47 is not inserted into the socket 41, and voltage low when the plug 47 is inserted into the socket 41. The phone chip 1 is configured to treat a transition between these steps as an interrupt signal, indicative of the plug being inserted or removed from the socket 41.

A second way in which this can be realized is shown in FIG. 3. In this figure the elements that correspond exactly to those of FIG. 2 are labelled by the same reference numerals. This system differs from the one in FIG. 2 in that the mechanical switch 55 is replaced by two leads 61 in the socket 41 (respectively connected to the line 49 and the ground 57) and two contacts 63 in the plug 47 (connected to each other). The leads 61 contact respective ones of the contacts 63 when the plug 47 is inserted into the socket, and thus connect the line 49 to the ground 57. Thus, the line 49 is strapped to high or low, and the transition between these states again acts as an interrupt signal.

Both of these known systems suffer from the problem that they require the plug and/or switch to include additional components (e.g., the pull-up resistor 53, the mechanical switch 55 and/or the contacts 61, 63).

Furthermore, the technique requires that the phone chip 1 is provided with the additional input for the line 49.

Additionally, the line 49 requires routing between the socket 41 and the phone chip 1, thereby complicating the layout of the printed circuit board on which the phone chip 1 is conventionally mounted.

### SUMMARY OF THE INVENTION

The present invention aims to provide a new and useful communication device, and a phone chip for use in such a device. In particular, the present invention aims to make it unnecessary for a separate line to be provided for an interrupt signal to be generated for the phone chip to indicate the presence of an external acoustic transducer device.

In general terms, the present invention proposes that the phone chip should be capable of measuring an impedance of the socket, which impedance varies according to whether an external acoustic transducer is connected to the socket. Thus, the phone chip is able to determine whether the socket is connected to an acoustic transducer based on the measurement.

In this document the term “impedance” is used to include within its scope both impedance as conventionally defined (i.e., a complex value), and also Ohmic resistance. An acoustic transducer is defined here as a device that is capable of generating sound based on electrical signals generated by the communication device and/or that is capable of generating electrical signals based on sound signals it receives.

Specifically, in a first aspect the invention proposes a communication device having an interface including multiple electrical contacts for connection to respective electrical contacts of an acoustic transducer device. The communication device includes a detection circuit for obtaining a signal indicative of an impedance value between at least two of the contacts of the interface. The detection circuit uses the signal to determine whether the acoustic transducer device is connected to the communication device. A control unit modifies the operation of the interface based on the result of the determination.

In a second aspect the invention proposes a phone chip for use in a communication device. The phone chip includes an interface having multiple electrical contacts for communicating electrical signals with an external acoustic transducer device. A detection circuit obtains a signal indicative of an impedance value between at least two of the contacts of the interface, and uses the signal to determine whether the acoustic transducer device is connected to the communication device. A control mechanism can modify the operation of the interface based on the result of the determination.

### BRIEF DESCRIPTION OF THE DRAWINGS

Preferred features of the invention will now be described, for the sake of illustration only, with reference to the following figures in which:

FIG. 1 shows schematically the structure of certain known communication devices (digital telephones);

FIG. 2 shows schematically a first technique used by the known communication devices to determine if an external acoustic transducer is connected;

FIG. 3 shows schematically a second technique used by known communication devices to determine if an external acoustic transducer is connected;

FIG. 4 shows schematically a portion of a communication system which is an embodiment of the invention; and

FIG. 5, which is composed of FIGS. 5a and 5b, illustrates configurations of a portion of a detection unit provided in a phone chip of the embodiment of FIG. 4.

### DETAILED DESCRIPTION OF ILLUSTRATIVE EMBODIMENTS

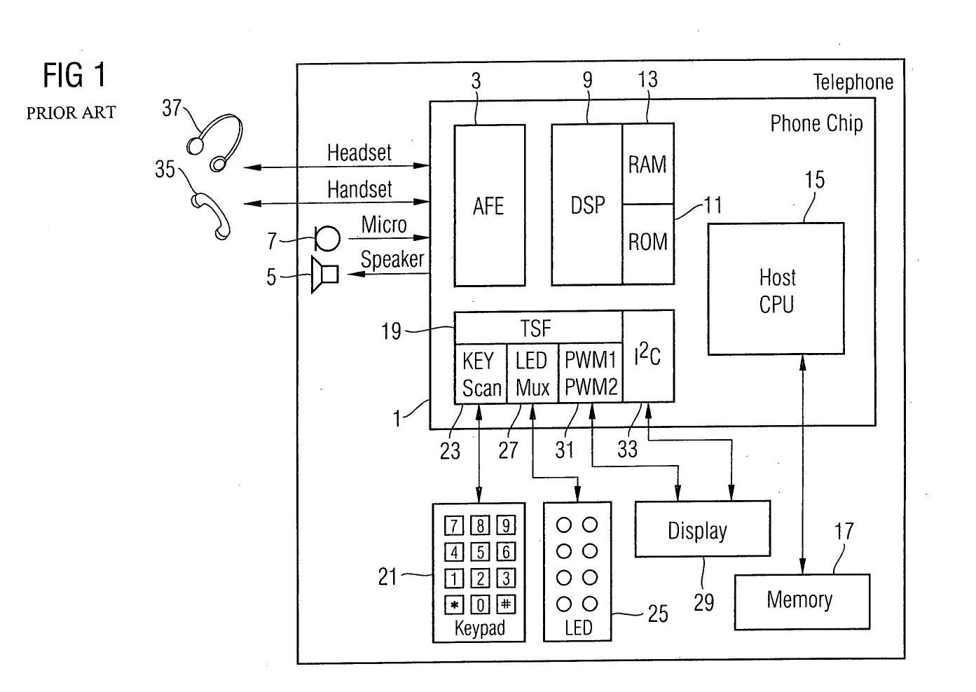

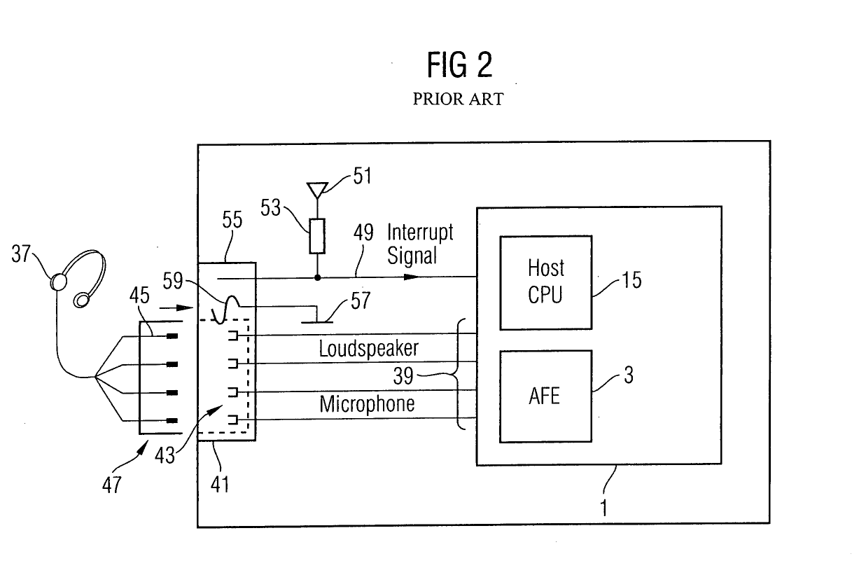

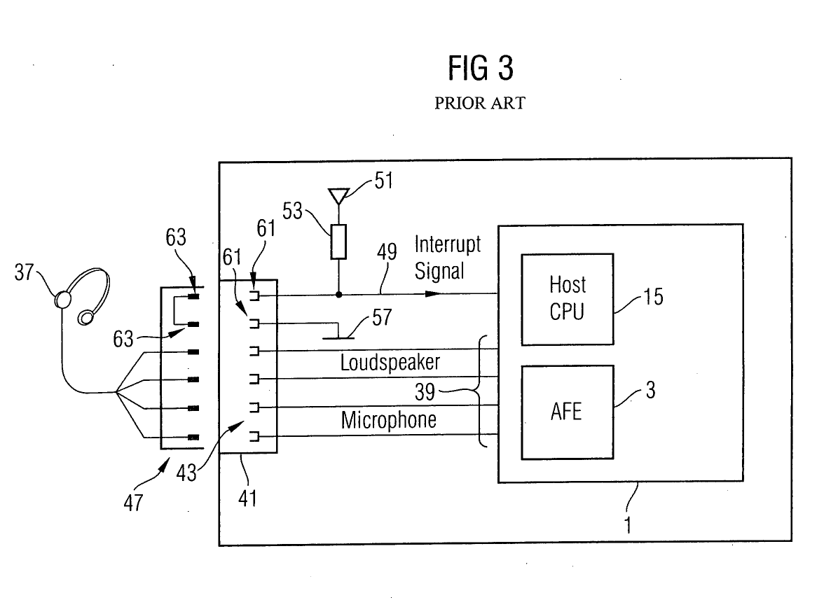

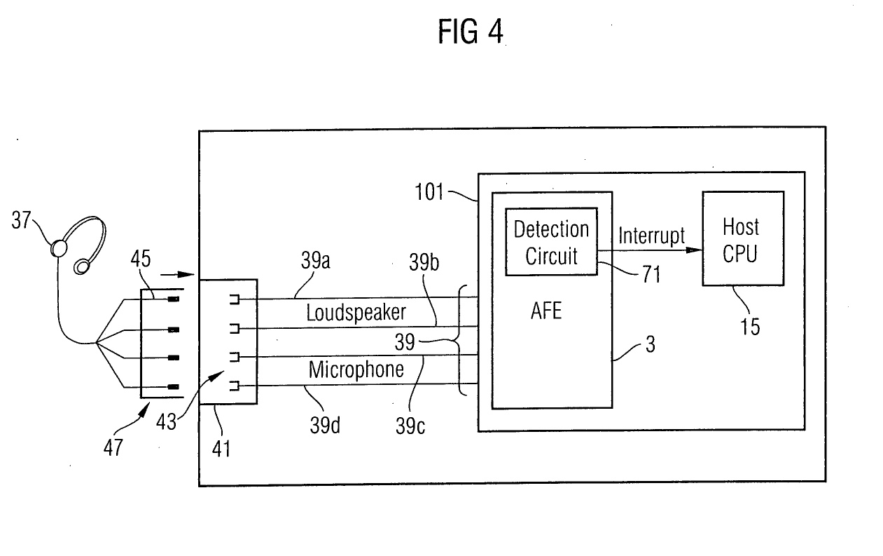

The embodiment of the invention described here is a communication device that has an overall structure according to FIG. 1. However, the internal structure of the communication device is somewhat different, as illustrated in FIG. 4, which shows the structure in more detail (omitting for simplicity the portions of the communication system of FIG. 1 which are not shown either in FIGS. 2 and 3). In particular, the embodiment uses a different technique for detecting if the communication device is connected to an external acoustic transducer. Elements of FIG. 4 that correspond to those of FIGS. 1 to 3 are labelled by the same reference numerals, except that the phone chip itself is labelled 101.

The phone chip 101 of FIG. 4 has generally the same construction as the phone chip 1 of FIGS. 1 to 3, but it does not have an input for receiving an interrupt signal indicating if an acoustic device is connected to the socket 41. However, the phone chip 101 of FIG. 4 includes, in comparison to the phone chip of FIGS. 2 and 3, an additional detection circuit 71, which is part of the AFE 3.

Whereas in FIGS. 2 and 3, the socket 41 was configured to include components for generating an interrupt signal, the socket 41 of FIG. 4 includes no such components, and is not connected to the phone chip 101 by a line for carrying an interrupt signal. The socket 41 of FIG. 4 includes only contacts 43 for connection to corresponding contacts 45 of a plug 47 of the external acoustic device (e.g., a headset 37).

The detection circuit 71 is arranged to measure an impedance between at least two of the leads 39a, 39b of the interface 39. Preferably, these two leads 39a, 39b are leads which, when the plug 47 is connected to the socket 41, carry an output signal that powers the loudspeaker (rather than leads 39c, 39d, which carry a signal obtained from the microphone). This is because the impedance properties of the loudspeaker are generally known, whereas those of the microphone are not. Also, certain sorts of microphones may possibly be damaged by a signal applied to their output lines. The detection circuit is arranged to develop a voltage signal between the leads 39a, 39b of the interface 39 and determine whether a plug is connected to the socket 41. This is done by a process which, in effect, amounts to a measurement of an impedance value R_{L} between the leads 39a, 39b. For example, if the plug 47 is not connected to the socket 41, then the voltage between the leads 39a, 39b will simply be equal to a high voltage value (i.e., R_{L} is very high), whereas if the plug 47 is connected to the socket 41 then the voltage value between the leads 39a, 39b will in general be different (i.e., indicative of a lower value of R_{L}).

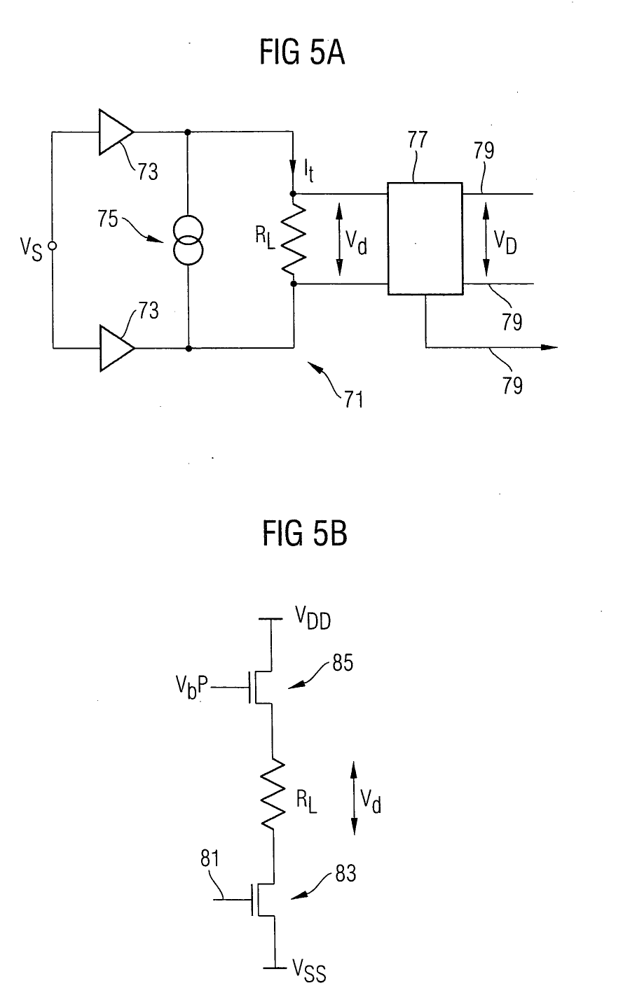

FIG. 5a shows a first possible form of the detection circuit 71. According to this circuit, a voltage source V_{S} and two amplifiers 73 provide the normal driving signal to an external loudspeaker. However, when it is desired to test whether the acoustic transducer is connected, the loudspeaker driving signal is disabled (e.g., by disabling the amplifiers 73), and their role is taken over by a current source 75. The current source 75 generates a known current It between the two leads of the interface 39 (i.e., across the impedance R_{L}). A high impedance voltage detection unit 77 measures the voltage V_{d} across R_{L} and compares it to the voltage difference V_{D} between two reference voltage inputs 79. According to whether V_{d} is greater or less than V_{D}, the unit 77 outputs a different voltage signal as its output 79. This output 79 functions as an interrupt signal for the phone chip 101.

The phone chip 101 is configured to react to this interrupt signal just as the phone chips 1 of FIGS. 2 and 3 react to the interrupt signal on the line 49. In particular, it is used to modify how the interface 39 is used (e.g., by ceasing to transmit and/or listen for signals through the interface 39 if it is determined that the plug 47 is removed from the socket 41, or conversely starting to transmit signals if it is determined that the plug 47 is inserted into the socket 41).

Naturally, the detection circuit 71 should not prevent the leads of the interface 39 to which it is connected from performing their normal function. For this reason, the current source 75 preferably only operates intermittently (e.g., periodically) as a test.

FIG. 5b is an implementation example of the current source 75 of FIG. 5a. The detection circuit preferably includes two inputs (e.g., from a timing circuit), shown as V_{b}P and 81 in FIG. 5b. The signal 81 is high when a detection is to be carried out, and otherwise low. The signal V_{b}P is at a bias value when detection is to be carried out, and otherwise high. The input 81 controls an nMOS transistor 83, which is in series with a pMOS transistor 85 and the effective impedance R_{L} between the known voltage values V_{DD} and V_{SS}. The pMOS transistor 85 is biased to be on during detection periods by a signal V_{b}P.

Although only a single embodiment of the invention has been described, many variations are possible within the scope of the invention as will be clear to a skilled reader.

What is claimed is:

1. A device comprising:
an interface including multiple electrical contacts;
a detection circuit for obtaining a signal indicative of an impedance value between at least two of the electrical contacts of the interface, and using the signal to determine if an acoustic transducer device is connected to the communication device via the interface; and
a control unit for modifying the operation of the interface based on the result of the determination.

2. The device according to claim 1, wherein the detection circuit and control unit are provided within a one-piece electrical component that further includes a driver for generating electrical signals for driving an acoustic transducer device coupled to the interface.

3. The device according to claim 1, further comprising a switching circuit for alternately putting the detection circuit into a detection state in which it outputs said signal, or into a non-detection circuit in which it does not output said signal.

4. The device according to claim 1, wherein the impedance value is measured between the electrical contacts of the interface that are for transmitting an electrical signal to the external acoustic transducer device.

5. The device according to claim 1, wherein the device includes a phone chip such that the interface, the detection circuit and the control unit are each formed on a single semiconductor chip.

6. The device according to claim 1, wherein the detection unit is arranged to output said signal as a selected one of two states that respectively indicate that said impedance value is above or below a predetermined level.

7. The device according to claim 1, wherein the detection circuit comprises:
first and second amplifiers, each having an output;
a voltage source coupled to each of the first and second amplifiers;
an impedance detector with a first set of inputs coupled between the outputs of the first and second amplifiers and a second set of inputs coupled between the at least two of the electrical contacts of the interface.

8. The device according to claim 7, wherein the impedance detector comprises:
a current source coupled between the outputs of the first and second amplifiers;
a resistive element coupled between the outputs of the first and second amplifiers; and
a voltage comparator with a first set of inputs coupled between the outputs of the first and second amplifiers and a second set of inputs coupled between the at least two of the electrical contacts of the interface.

9. The device according to claim 1, wherein the detection circuit comprises:
a voltage comparator with a first and second inputs coupled to the at least two of the electrical contacts of the interface, the voltage comparator also including third and fourth inputs;
a current source coupled between the third and fourth inputs of the voltage comparator; and
a resistive element coupled between the third and fourth inputs of the voltage comparator.

10. The device according to claim 9, wherein the current source comprises:
a resistor;
an enable transistor coupled between the resistor and a first reference voltage node, the enable transistor being controlled by an enable signal; and
a bias transistor coupled between the resistor and a second reference voltage node, the bias transistor being controlled by a bias signal.

11. The device according to claim 1 in combination with an external acoustic transducer device that is coupled to the device via the interface.

12. The device according to claim 11, wherein the external acoustic transducer device comprises a headset having sound generation elements.

13. A device comprising:
an interface including multiple electrical contacts for connection to respective electrical contacts of an acoustic transducer device;
means for obtaining a signal indicative of an impedance value between at least two of the electrical contacts of the interface, and for using the signal to determine whether the acoustic transducer device is connected to the communication device; and
means for modifying operation of the interface based on the result of the determination.

14. The device according to claim 13 in combination with an external acoustic transducer device that is coupled to the device via the interface.

15. A method of operating a device, the method comprising:
generating an audio signal:
measuring an impedance across audio outputs;
comparing the measured impedance with a reference signal to generate a signal;
preventing the audio signal from being provided to the audio outputs if the signal has a first value; and
providing the audio signal to the audio outputs if the signal has a second value different than the first value.

16. The method of claim 15, wherein comparing comprises comparing the measured impedance with the reference signal to generate a signal indicative of if an acoustic transducer device is coupled to the audio outputs.

17. The method of claim 16, further comprising generating the reference signal, the generating comprising:
causing a reference current to flow through a resistive element; and
comparing a voltage across the resistive element to a voltage across the audio outputs.

18. The method of claim 15, further comprising generating the reference signal, the generating comprising:
causing a reference current to flow through a resistive element; and
comparing a voltage across the resistive element to a voltage across the audio outputs.

19. The method of claim 15, wherein providing the audio signal to the audio outputs comprises coupling amplifiers to the audio outputs.

20. The method of claim 19, wherein measuring an impedance across audio outputs comprises disabling the amplifiers.
